(19) United States
(12) Patent Application Publication
(10) Pub. No.: US 2026/0208214 A1
(43) Pub. Date: Jul. 23, 2026

(54) ELECTROSTATIC ATOMIZER

(71) Applicant: Panasonic Intellectual Property Management Co., Ltd., Osaka (JP)

(72) Inventors: MIHO TANAKA, Kyoto (JP); YOHEI ISHIGAMI, Osaka (JP); MAKOTO IMAI, Shiga (JP); HIDETOSHI HATA, Osaka (JP)

(21) Appl. No.: 19/141,357

(22) PCT Filed: Dec. 25, 2023
(86) PCT No.: PCT/JP2023/046324

§ 371 Date: Jun. 20, 2025

(30) Foreign Application Priority Data
Jan. 20, 2023 (JP) 2023-007591

(51) Int. Cl. B05B 5/00; B05B 5/053

(52) U.S. Cl. CPC B05B 5/007; B05B 5/0535

(57) ABSTRACT

The present disclosure improves production efficiency of a functional substance. An electrostatic atomizing apparatus of the present disclosure includes a voltage application circuit. The voltage application circuit applies an output voltage to a load to cause electric discharge in a liquid held by a discharge electrode. The voltage application circuit performs operation of one cycle a plurality of times, the operation of one cycle including executing a plurality of modes including a first mode to a third mode in a predetermined order. The first mode is a mode in which the output voltage is increased with time. The second mode is a mode in which the output voltage is maintained at a voltage of a predetermined magnitude or more. The third mode is a mode in which the output voltage is decreased with time. The predetermined magnitude is 3 kV or more. The time from the start to the end of the second mode is 40% or more of the length of the one cycle.

### BACKGROUND

### 1. Technical Field

The present disclosure relates to an electrostatic atomizing apparatus.

### 2. Description of the Related Art

The voltage application device (that is, the electrostatic atomizing apparatus) described in Patent Literature 1 includes a voltage application circuit. The voltage application circuit applies a voltage to a load including an discharge electrode holding a liquid to cause electric discharge in the liquid held by the discharge electrode. By causing the electric discharge in the liquid held by the discharge electrode, an active ingredient such as a radical is generated.

### CITATION LIST

### Patent Literature

Patent Literature 1: Unexamined Japanese Patent Publication No. 2019-046635 A

### SUMMARY

### Technical Problem

In the voltage application device described in Patent Literature 1, when the voltage applied to the load decreases, the liquid is contracted relatively largely. Therefore, when the voltage is increased thereafter, the liquid is not sufficiently extended, and as a result, the generation efficiency of the functional substance may decrease.

An object of the present disclosure is to provide an electrostatic atomizing apparatus in which the efficiency of generating a functional substance (for example, radicals) is improved.

### Solution to Problem

An electrostatic atomizing apparatus according to one aspect of the present disclosure includes a voltage application circuit. The voltage application circuit is configured to apply an output voltage to a load including a discharge electrode for holding a liquid to cause electric discharge in the liquid held by the discharge electrode. The voltage application circuit is configured to perform operation of one cycle a plurality of times, the operation of one cycle including executing a plurality of modes in a predetermined order. The plurality of modes include a first mode, a second mode subsequent to the first mode, and a third mode subsequent to the second mode. The first mode is a mode in which the output voltage is increased with time. The second mode is a mode in which the output voltage is maintained at a voltage equal to or higher than a predetermined magnitude. The third mode is a mode in which the output voltage is decreased with time. The predetermined magnitude of the output voltage is 3 kV or more. A time from start to end of the second mode is 40% or more of a length of the one cycle.

### Advantageous Effects of Invention

The present disclosure has an advantage that the efficiency of generating a functional substance such as a radical can be improved.

### BRIEF DESCRIPTION OF DRAWINGS

FIG. 1 is a block diagram of an electrostatic atomizing apparatus according to an embodiment.

FIG. 2A is a schematic diagram illustrating a state in which a liquid held by a discharge electrode is extended in the electrostatic atomizing apparatus according to the embodiment.

FIG. 2B is a schematic diagram illustrating a state where the liquid held by the discharge electrode is contracted in the electrostatic atomizing apparatus according to the embodiment.

FIG. 3A is a perspective view illustrating a specific example of the discharge electrode and a counter electrode in the electrostatic atomizing apparatus according to the embodiment.

FIG. 3B is a cross-sectional view taken along line X1-X1 of FIG. 3A.

FIG. 4 is a side view illustrating a tip shape of the discharge electrode according to the embodiment.

FIG. 5 is a circuit diagram illustrating an example of the electrostatic atomizing apparatus according to the embodiment.

FIG. 6 is a graph and a schematic diagram schematically illustrating a change in an output voltage, and extension and contraction of a liquid of the electrostatic atomizing apparatus according to the embodiment.

FIG. 7 is a graph and a schematic diagram schematically illustrating a change in an output voltage and extension and contraction of a liquid of an electrostatic atomizing apparatus according to a comparative example.

### DESCRIPTION OF EMBODIMENT

### Embodiment

Hereinafter, an electrostatic atomizing apparatus 10 according to an embodiment will be described with reference to the drawings. However, the following embodiment is merely one of various embodiments of the present disclosure. The following embodiments can be variously modified depending on design, as long as the object of the present disclosure can be achieved. In addition, each drawing described in the following embodiments is a schematic diagram, and a ratio of the size and the thickness of each component in the drawing does not necessarily reflect an actual dimensional ratio.

### (1) Overview

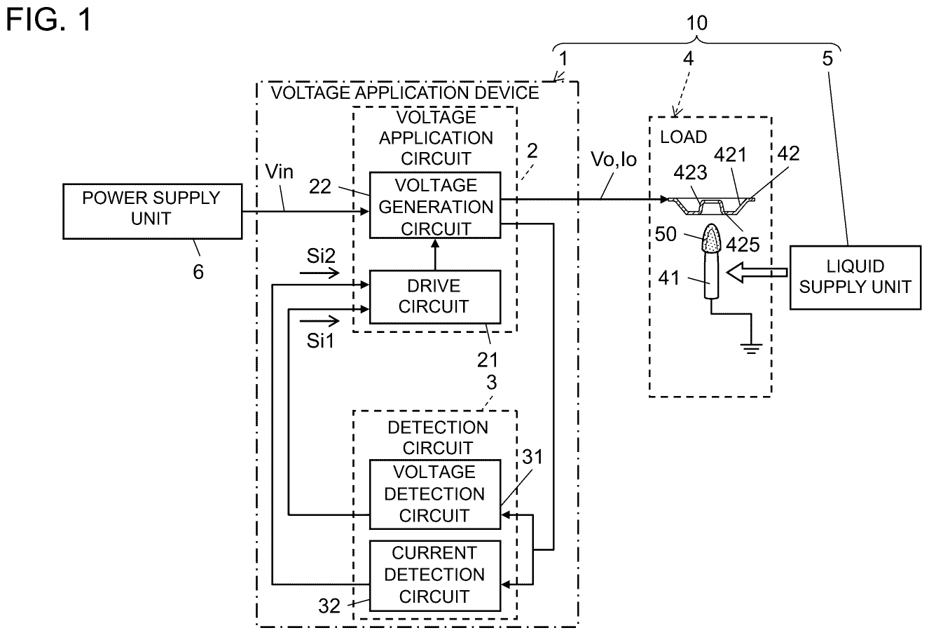

First, an outline of the electrostatic atomizing apparatus 10 according to the present embodiment will be described with reference to FIG. 1. FIG. 1 is a block diagram of the electrostatic atomizing apparatus 10 according to the embodiment.

As shown in FIG. 1, the electrostatic atomizing apparatus 10 according to the present embodiment includes a voltage application device 1, a load 4, and a liquid supply unit 5.

The voltage application device 1 is a device that applies a voltage Vo for causing electric discharge to the load 4, and includes a voltage application circuit 2 and a detection circuit 3. That is, the electrostatic atomizing apparatus 10 includes the voltage application circuit 2. Hereinafter, the voltage Vo is referred to as an output voltage Vo.

The load 4 includes a discharge electrode 41 and a counter electrode 42. The counter electrode 42 is an electrode disposed to face the discharge electrode 41 in such a manner that a gap is formed between the discharge electrode 41 and the counter electrode 42. That is, the discharge electrode 41 is disposed to face the counter electrode 42. When the output voltage Vo is applied between the discharge electrode 41 and the counter electrode 42, electric discharge occurs between the discharge electrode 41 and the counter electrode 42.

The liquid supply unit 5 supplies a liquid 50 to the discharge electrode 41.

As described above, the electrostatic atomizing apparatus 10 according to the present embodiment includes, as constituent elements, the voltage application circuit 2, the detection circuit 3, the liquid supply unit 5, the discharge electrode 41, and the counter electrode 42. However, the electrostatic atomizing apparatus 10 only needs to include the voltage application circuit 2 as a constituent element. Each of the detection circuit 3, the liquid supply unit 5, the discharge electrode 41, and the counter electrode 42 does not have to be included in the constituent elements of the electrostatic atomizing apparatus 10.

In electrostatic atomizing apparatus 10 according to the present embodiment, the voltage application circuit 2 applies the output voltage Vo between the discharge electrode 41 and the counter electrode 42 in a state where the liquid 50 is held by the discharge electrode 41. The state where liquid 50 is held by the discharge electrode 41 is, for example, a state where the liquid 50 adheres to the surface of discharge electrode 41. That is, the voltage application circuit 2 applies the output voltage Vo to the load 4 including discharge electrode 41 holding the liquid 50. Thus, the voltage application circuit 2 causes electric discharge in the liquid 50 held by the discharge electrode 41. That is, the voltage application circuit 2 allows the load 4 including the discharge electrode 41 (more specifically, between the discharge electrode 41 and the counter electrode 42) to cause the electric discharge. Accordingly, the electric discharge occurs in the liquid 50 held by the discharge electrode 41, and the liquid 50 is electrostatically atomized. In the present embodiment, the liquid 50 held by the discharge electrode 41, that is, the liquid 50 to be electrostatically atomized is also simply referred to as “liquid 50”.

The voltage application circuit 2 is electrically connected to the discharge electrode 41 and the counter electrode 42. Specifically, the counter electrode 42 is electrically connected to a positive electrode (for example, plus) of the voltage application circuit 2. The discharge electrode 41 is electrically connected to a negative electrode (for example, ground) of the voltage application circuit 2. The voltage application circuit 2 applies the output voltage Vo between the discharge electrode 41 and the counter electrode 42.

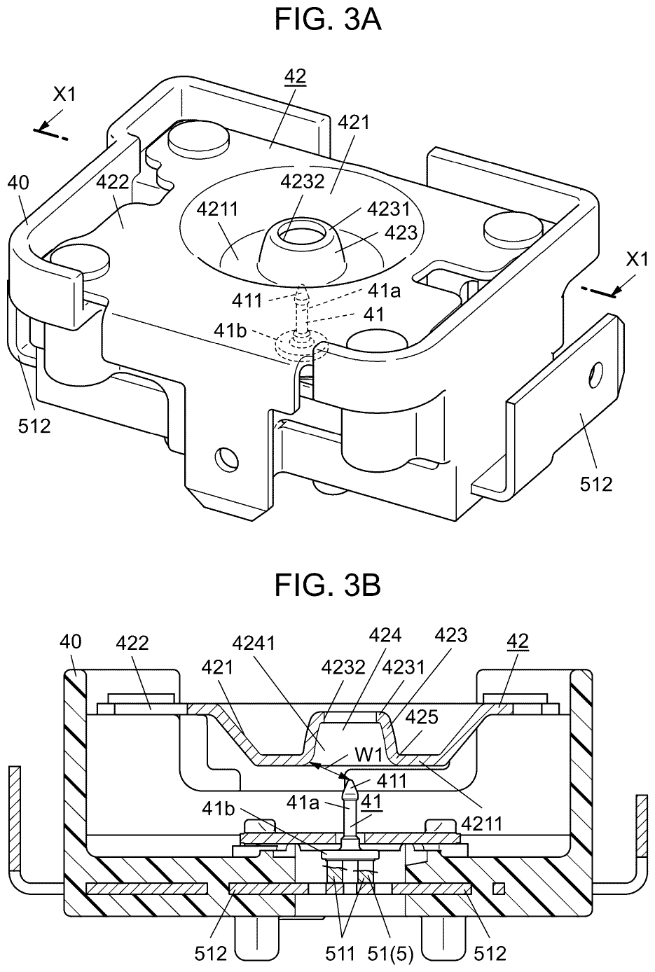

The voltage application circuit 2 applies the output voltage Vo to the load 4 (more specifically, between the discharge electrode 41 and the counter electrode 42) to cause the electric discharge between the discharge electrode 41 and the counter electrode 42. In particular, in the present embodiment, the voltage application circuit 2 periodically changes magnitude of the output voltage Vo to intermittently generate the electric discharge. That is, the output voltage Vo alternately repeats a period during which the output voltage Vo increases to a high voltage and a period during which the output voltage Vo decreases to a low voltage. The periodic fluctuation of the magnitude of the output voltage Vo causes mechanical vibration in the liquid 50. The “high voltage” here may be a voltage set to allow the discharge electrode 41 to cause the electric discharge, and is, for example, a voltage having a peak of about 7.0 kV. However, the voltage value of the output voltage Vo is not limited to about 7.0 kV, and is appropriately set in accordance with, for example, shapes of the discharge electrode 41 and the counter electrode 42 or a distance W1 between the discharge electrode 41 and the counter electrode 42 (see FIG. 3B, which will be described later). In addition, the “low voltage” may be a voltage set such that the electric discharge does not occur on the discharge electrode 41. The “low voltage” may be a voltage lower than the “high voltage”, which has been described above, and may be either greater than 0 V or 0 V. Hereinafter, “the magnitude of the output voltage Vo periodically varies” may be referred to as “the output voltage Vo periodically varies”.

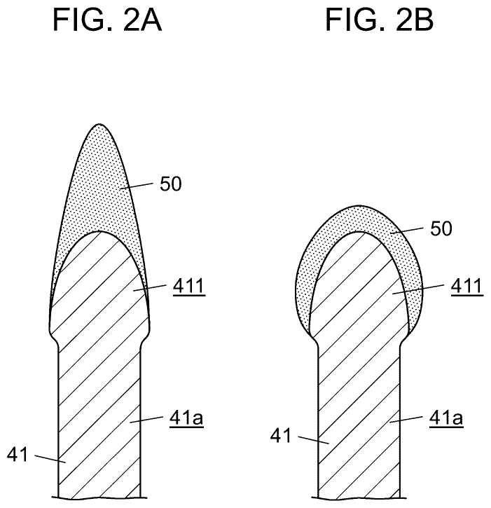

Specifically, when the output voltage Vo is applied to the load 4, in a period during which the output voltage Vo is the high voltage, the liquid 50 held by the discharge electrode 41 is extended by receiving a force due to an electric field, as shown in FIG. 2A. FIG. 2A is a schematic diagram illustrating a state in which the liquid 50 held by the discharge electrode 41 is extended in the electrostatic atomizing apparatus 10 according to the embodiment. Thus, the liquid 50 has a conical shape referred to as a Taylor cone. The electric field is concentrated at a tip portion (that is, an apex portion) of the Taylor cone, thereby generating the electric discharge. At this time, the sharper the tip portion of the Taylor cone is, that is, the smaller the apex angle of the cone is (that is, the sharper the apex angle is), the smaller electric field strength required for dielectric breakdown is, and the more easily the electric discharge occurs. In addition, in the period during which the output voltage Vo is low, as shown in FIG. 2B, the liquid 50 held by discharge electrode 41 is contracted more than in the period during which output voltage Vo is high, since the force due to the electric field decreases. FIG. 2B is a schematic view showing a state where the liquid 50 held by the discharge electrode 41 is contracted in the electrostatic atomizing apparatus 10 according to the embodiment. Accordingly, the liquid 50 has a substantially spherical shape. When the output voltage Vo periodically varies, the liquid 50 held by discharge electrode 41 is deformed alternately into the shape shown in FIG. 2A and the shape shown in FIG. 2B in accordance with the mechanical vibration. That is, the liquid 50 is extended and contracted. As a result, since the Taylor cone as described above is periodically formed, the electric discharge is intermittently generated in accordance with a timing at which the Taylor cone as shown in FIG. 2A is formed. In FIGS. 2A and 2B, the liquid 50 is hatched with dots so that the discharge electrode 41 and the liquid 50 can be easily distinguished from each other.

The electrostatic atomizing apparatus 10 causes the electric discharge between the discharge electrode 41 and the counter electrode 42 of the load 4 to generate radicals and electrostatically atomize the liquid 50 held by the discharge electrode 41. Thus, the electrostatic atomizing apparatus 10 generates a charged fine particle liquid (for example, a charged fine particle water) of nanometer size containing the radicals in fine droplets of the liquid 50 which has been electrostatically atomized. That is, the electrostatic atomizing apparatus 10 functions as a charged fine particle liquid generating apparatus. The charged fine particle liquid may be a liquid other than water. Hereinafter, the radical and the charged fine particle liquid may be collectively referred to as a functional substance or an active ingredient. The functional substance exerts useful effects in various situations in addition to effects such as sterilization, deodorization, skin moisturization, food freshness preservation (that is, freshness preservation), and virus inactivation.

The radicals are also referred to as free radicals. Each of the radicals is an atom or molecule having an unpaired electron.

The electrostatic atomizing apparatus 10 described above generates the charged fine particle liquid containing the radicals, thereby making it possible to prolong life of the radicals as compared with the case where the radicals are released into the air alone. Further, since each of the charged fine particle liquids has, for example, a nanometer size, the charged fine particles liquid can be floated in a relatively wide range.

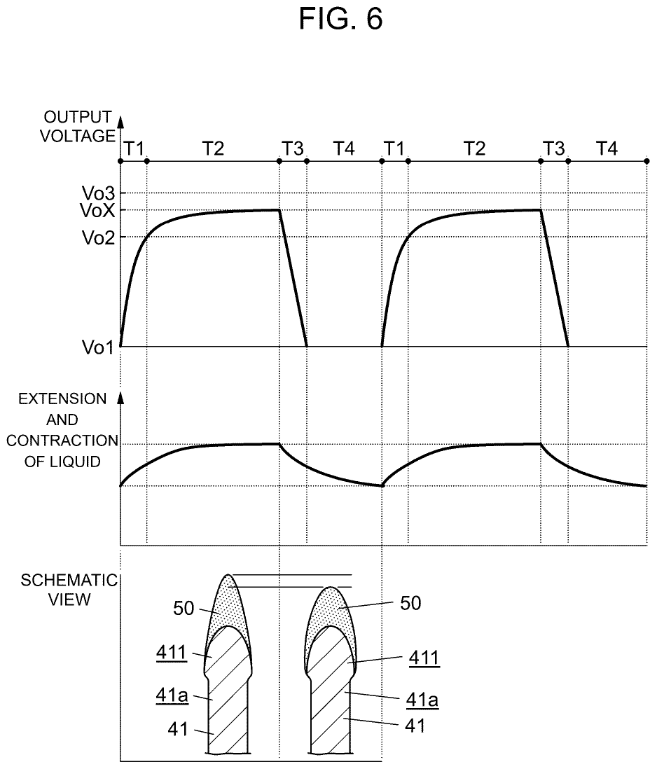

In the electrostatic atomizing apparatus 10 according to the present embodiment, the voltage application circuit 2 performs operation of one cycle a plurality of times, the operation of one cycle including executing a plurality of modes (that is, a plurality of operation modes) in a predetermined order (see FIG. 6, which will be described later). The plurality of modes include a first mode, a second mode subsequent to the first mode, and a third mode subsequent to the second mode.

FIG. 6 is a graph and a schematic diagram schematically showing a change in the output voltage Vo and the extension and the contraction of the liquid 50 of the electrostatic atomizing apparatus 10 according to the embodiment. In FIG. 6, a period T1 is a time from the start to the end of the first mode, a period T2 is a time from the start to the end of the second mode, and a period T3 is a time from the start to the end of the third mode.

The first mode is a mode in which the output voltage Vo is increased with time. The second mode is a mode in which the output voltage Vo is maintained at a voltage of a predetermined magnitude Vo2 or more. The third mode is a mode in which the output voltage Vo is decreased with time. The predetermined magnitude Vo2 of the output voltage Vo is 3 kV or more. The time from the start to the end of the second mode is 40% or more of the length of the one cycle.

In the above configuration, the voltage application circuit 2 performs the operation of the second mode, so that the time during which the output voltage Vo equal to or greater than the predetermined magnitude Vo2 is applied to the load 4 is longer than that in the case where the mode is shifted to the third mode immediately after the first mode. As a result, the vibration of the liquid 50 is made uniform, and the liquid 50 is electrically discharged in a uniformly extended state every time. Then, the voltage to be electrically discharged is uniformized, and the electric discharge can be performed with the minimum applied voltage, thereby improving the generation efficiency of the functional substance.

### (2) Details

Next, details of the electrostatic atomizing apparatus 10 according to the present embodiment will be described with reference to FIGS. 1 to 7.

### (2.1) Overall Configuration

As shown in FIG. 1, the electrostatic atomizing apparatus 10 according to the present embodiment includes the voltage application device 1, the load 4, and the liquid supply unit 5. The voltage application device 1 includes the voltage application circuit 2 and the detection circuit 3. The load 4 includes the discharge electrode 41, the counter electrode 42, and the housing 40 (see FIG. 3A, which will be described later). The liquid supply unit 5 supplies the liquid 50 to the discharge electrode 41.

### (2.1.1) Electrodes

FIG. 3A is a perspective view showing a specific example of the discharge electrode 41 and the counter electrode 42 in the electrostatic atomizing apparatus 10 according to the embodiment. FIG. 3B is a cross-sectional view taken along line X1-X1 of FIG. 3A. As shown in FIGS. 3A and 3B, each of the discharge electrode 41 and the counter electrode 42 is held by the housing 40. The housing 40 has electrical insulation properties. The housing 40 is made of synthetic resin, for example.

### Discharge Electrode

The discharge electrode 41 is a rod-shaped electrode. The discharge electrode 41 includes a shaft 41a and a base end portion 41b. The shaft 41a is formed in a rod shape having a circular cross section. The shaft 41a has a distal end portion 411 at a first end in the longitudinal direction thereof. The base end portion 41b is continuously and integrally formed at a second end (i.e., an end portion opposite to the distal end portion 411) of the shaft 41a in the longitudinal direction. The base end portion 41b has a flat plate shape. The distal end portion 411 has a tapered shape in which the cross-sectional area thereof decreases toward the distal end of the shaft 41a. That is, the discharge electrode 41 is a needle electrode having the distal end portion 411 formed in a tapered shape. Here, the “tapered shape” is not limited to a shape in which the tip is sharply pointed, and includes a shape in which the tip is rounded as illustrated in FIGS. 2A and 2B.

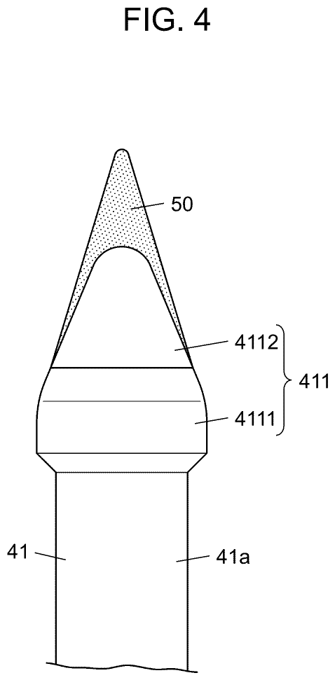

The shape of distal end portion 411 of the discharge electrode 41 will be described with reference to FIG. 4. FIG. 4 is a side view illustrating a tip shape of the discharge electrode 41 according to the embodiment. In FIG. 4, dot hatching is provided to the liquid 50 so that the distal end portion 411 and the liquid 50 can be easily distinguished from each other.

The shape of distal end portion 411 of the discharge electrode 41 is, for example, a shape including a conical portion. Here, the conical portion has a conical shape. The shape of the portion of the distal end portion 411 facing the counter electrode 42 (here, the shape of the tip of the conical portion) is, for example, an R shape. That is, the portion of the distal end portion 411 on the side opposite to the base end portion 41b (see FIG. 3B) has an R shape. The “R-shape” in the present disclosure may include that a surface of a member is rounded (that is, has roundness). The distal end surface of the distal end portion 411 of the present embodiment includes a curved surface having a convex roundness. In the cross-sectional view including the central axis of the discharge electrode 41, the distal end surface of the discharge electrode 41 of the present embodiment is continuously connected from the side surface of the distal end portion 411. In the cross-sectional view including the central axis of the discharge electrode 41, the distal end surface of the discharge electrode 41 is formed in an arc shape and does not include a corner. That is, the entire distal end surface of the discharge electrode 41 is a curved surface (for example, a convex surface). For example, the shape of the distal end portion 411 is a hemispherical shape or a substantially hemispherical shape.

The distal end portion 411 has a first portion 4111 and a second portion 4112. The first portion 4111 is provided between the second portion 4112 and the base end portion 41b. The first portion 4111 has a columnar shape that is flat in the axial direction of the discharge electrode 41. The second portion 4112 is a portion of the distal end portion 411 that is farther from the base end portion 41b than from the first portion 4111. The shape of the second portion 4112 is conical. In short, the distal end portion 411 has the first portion 4111 having a columnar shape and the second portion 4112 corresponding to the above-described conical portion.

When a voltage is applied between the discharge electrode 41 and the counter electrode 42, as shown in FIG. 4, the liquid 50 held by the discharge electrode 41 receives the force due to the electric field and forms a conical shape called the Taylor cone. As shown in FIG. 4, the shape of the Taylor cone is a conical shape along the conical portion (i.e., the second portion 4112) of the distal end portion 411 of the discharge electrode 41. The second portion 4112 of the distal end portion 411 of the discharge electrode 41 is covered with the liquid 50 having the Taylor cone shape. That is, in the electrostatic atomizing apparatus 10 according to the present embodiment, the second portion 4112 constitutes a part of the distal end portion 411 covered in the liquid 50 having the Taylor cone shape.

### Counter Electrode

As shown in FIGS. 3A and 3B, the counter electrode 42 is disposed so as to face the distal end portion 411 of the discharge electrode 41. The counter electrode 42 includes, for example, a support portion 422 having a shape of a flat plate, and a first recess portion 421 is provided substantially at the center of the support portion 422. The first recess portion 421 is formed in a truncated cone shape by recessing substantially the center of the support portion 422 toward the discharge electrode 41. A protruding base portion 423 is integrally formed at a central portion of a bottom wall 4211 of the first recess portion 421. The protruding base portion 423 is formed in a truncated cone shape (for example, a dome shape) by protruding a part of a bottom wall 4211 of the first recess portion 421 toward the side opposite to the discharge electrode 41. In other words, a second recess portion 424 having a truncated cone shape is formed in the bottom wall 4211 by recessing the central portion of the bottom wall 4211 in a direction opposite to the discharge electrode 41.

A direction in which the first recess portion 421 is recessed (that is, a direction in which the first recess portion 421 is recessed) and a direction in which the protruding base portion 423 protrudes (that is, a direction in which the second recess portion 424 is recessed) are opposite to each other. An opening 4232 having a shape of a circle is formed at a central portion of a top wall 4231 of the protruding base portion 423 (more specifically, at the central portion of the bottom wall of the second recess portion 424). The opening 4232 penetrates the top wall 4231 in the thickness direction of the top wall 4231.

As described above, the counter electrode 42 includes the first recess portion 421 having a truncated cone shape recessed toward the discharge electrode 41, the protruding base portion 423 having a truncated cone shape protruding from the bottom wall 4211 of the first recess portion 421 in a direction away from the discharge electrode 41, and the opening 4232 formed at the top wall 4231 of the protruding base portion 423.

Here, the thickness direction of counter electrode 42 (that is, the penetrating direction of the opening 4232) corresponds with the longitudinal direction of the discharge electrode 41. In the plan view (that is, when viewed in the thickness direction of the counter electrode 42), the distal end portion 411 of the discharge electrode 41 is located near the center of the opening 4232 of the counter electrode 42. When viewed in the direction orthogonal to the thickness direction of the counter electrode 42, the distal end portion 411 of the discharge electrode 41 is located outside the second recess portion 424 of the counter electrode 42, and is located between the bottom wall 4211 of the first recess portion 421 and the base end portion 41b of the discharge electrode 41. That is, a gap (that is, a space) of at least the opening 4241 of the second recess portion 424 of the counter electrode 42 is formed between the counter electrode 42 and the discharge electrode 41. In other words, the counter electrode 42 is disposed so as to face the discharge electrode 41 in such a manner that the gap is formed between the counter electrode 42 and the discharge electrode 41. The counter electrode 42 is spatially separated from the discharge electrode 41.

The protruding base portion 423 of the counter electrode 42 faces the discharge electrode 41, and is formed so as to have an axisymmetric shape about the shaft 41a of the discharge electrode 41 in the plan view. A peripheral edge of the opening 4241 of the second recess portion 424 is an annular edge portion 425 constituting a boundary portion between the bottom wall 4211 and the protruding base portion 423. In the plan view, the distal end portion 411 of the discharge electrode 41 is located at a center of the annular edge portion 425. That is, a distance W1 (see FIG. 3B) between the annular edge portion 425 and the distal end portion 411 is equal around the entire circumference of the annular edge portion 425.

### (2.1.2) Liquid Supply Unit

The liquid supply unit 5 supplies the liquid 50 for electrostatic atomization to the discharge electrode 41. As an example, the liquid supply unit 5 is realized using a cooling device 51 illustrated in FIG. 3B. That is, the liquid supply unit 5 includes the cooling device 51. The cooling device 51 cools the discharge electrode 41 to generate dew condensation water as the liquid 50 on the discharge electrode 41. Specifically, the cooling device 51 includes a pair of Peltier elements 511 and a pair of heat dissipation plates 512. The pair of Peltier elements 511 are held by the pair of heat dissipation plates 512. The cooling device 51 cools the discharge electrode 41 by energizing the pair of Peltier elements 511. The pair of heat dissipation plates 512 are held by the housing 40 by embedding a part of each of the pair of heat dissipation plates 512 in the housing 40. At least a portion of the pair of heat dissipation plates 512 that holds the Peltier elements 511 is exposed from the housing 40.

The pair of Peltier elements 511 are mechanically and electrically connected to the base end portion 41b of the discharge electrode 41 by, for example, soldering. The pair of Peltier elements 511 are mechanically and electrically connected to the pair of heat dissipation plates 512 by, for example, soldering. The pair of Peltier elements 511 are energized through the pair of heat dissipation plates 512 and the discharge electrode 41. The cooling device 51 constituting the liquid supply unit 5 cools the entire of the discharge electrode 41 through the base end portion 41b. As a result, moisture in the air condenses and adheres to the surface of the discharge electrode 41 as dew condensation water. The dew condensation water is held by the discharge electrode 41 as the liquid 50. That is, the liquid supply unit 5 is configured to cool the discharge electrode 41 and generate dew condensation water as the liquid 50 on the surface of the discharge electrode 41. In this configuration, the liquid supply unit 5 can supply the liquid 50 (for example, the dew condensation water) to the discharge electrode 41 by using moisture in the air, and thus it is not necessary to supply (in particular, actively supply) and replenish a liquid to the electrostatic atomizing apparatus 10.

### (2.1.3) Voltage Application Circuit and Detection Circuit

As shown in FIG. 1, the voltage application circuit 2 includes a drive circuit 21 and a voltage generation circuit 22. The drive circuit 21 is a circuit that drives the voltage generation circuit 22. The voltage generation circuit 22 is a circuit that receives power supply from the power supply unit 6 and generates the output voltage Vo that is a voltage to be applied to the load 4. The power supply unit 6 is, for example, a power supply circuit that generates a DC voltage of about several volts to ten and several volts. In the present embodiment, the power supply unit 6 is not included in the constituent element of the voltage application device 1. However, the power supply unit 6 may be included in the constituent element of the voltage application device 1. The voltage application circuit 2 generates the output voltage Vo by periodically boosting an input voltage Vin from the power supply unit 6, and applies the output voltage Vo to the load 4.

The voltage application circuit 2 is electrically connected to the load 4. The voltage application circuit 2 applies, to the load 4, the output voltage Vo which periodically varies. More specifically, the voltage application circuit 2 applies the output voltage Vo between the discharge electrode 41 and the counter electrode 42, by using the discharge electrode 41 as a negative electrode (for example, ground) and the counter electrode 42 as a positive electrode (for example, plus). When the voltage application circuit 2 applies the output voltage Vo to the load 4, a potential difference is generated between the discharge electrode 41 and the counter electrode 42 such that the counter electrode 42 has a high potential and the discharge electrode 41 has a low potential.

As described above, the plurality of modes of the voltage application circuit 2 include the first mode, the second mode subsequent to the first mode, and the third mode subsequent to the second mode. The plurality of modes further include a fourth mode subsequent to the third mode. The fourth mode is a mode in which the output voltage Vo is maintained at a predetermined lower limit voltage or less. In FIG. 6, a period T4 is a time from the start to the end of the fourth mode. The voltage application circuit 2 performs the operation of one cycle a plurality of times. The operation of one cycle including sequentially executing the first mode, the second mode, the third mode, and the fourth mode. That is, the first mode follows the fourth mode.

The first mode is a mode in which the output voltage Vo is increased with time. The second mode is a mode in which the output voltage Vo is maintained at a voltage equal to or higher than a predetermined magnitude Vo2 (see FIG. 6). In the second mode, the dielectric breakdown occurs between the discharge electrode 41 and the counter electrode 42 to start the electric discharge, and an output current lo (that is, an electric discharge current) is generated. The third mode is a mode in which the output voltage Vo is decreased with time. The third mode and the fourth mode are modes for interrupting the electric discharge by setting the output voltage Vo to be a voltage lower than a voltage at which the electric discharge occurs. That is, the third mode and the fourth mode are modes for interrupting the output current lo. After the fourth mode, the voltage application circuit 2 increases the output voltage Vo again in the first mode, and causes the electric discharge again in the second mode.

In the second mode, as shown in the schematic view of FIG. 6, the liquid 50 is maintained in the extended state. In the second mode, the electric discharge occurs at the distal end portion 411 of the discharge electrode 41. Thus, the liquid 50 held in the distal end portion 411 is electrostatically atomized.

By repeating the first to fourth modes, the output voltage Vo periodically fluctuates. Accordingly, the electric field acting on the liquid 50 held by the discharge electrode 41 periodically varies. As a result, the liquid 50 held by discharge electrode 41 mechanically vibrates in accordance with the variation in the output voltage Vo.

In the present embodiment, the voltage application circuit 2 operates based on a monitoring target of the detection circuit 3. More specifically, the voltage application circuit 2 controls the output voltage Vo based on the monitoring target of the detection circuit 3. Here, the “monitoring target” is the output current lo and the output voltage Vo of the voltage application circuit 2. That is, the detection circuit 3 detects the magnitudes of the output voltage Vo and the output current lo.

As shown in FIG. 1, the detection circuit 3 includes a voltage detection circuit 31 and a current detection circuit 32. The voltage detection circuit 31 monitors the output voltage Vo of the voltage application circuit 2, and detects the magnitude (i.e., the voltage value) of the output voltage Vo. Then, the voltage detection circuit 31 outputs a voltage detection signal Si1 including data of the magnitude of the output voltage Vo to the drive circuit 21 of the voltage application circuit 2. The current detection circuit 32 monitors the output current lo of the voltage application circuit 2, and detects the magnitude (i.e., the current value) of the output current lo. The current detection circuit 32 outputs a current detection signal Si2 including data of the magnitude of the output current lo to the drive circuit 21 of the voltage application circuit 2. The drive circuit 21 drives the voltage generation circuit 22 based on the voltage detection signal Si1 and the current detection signal Si2 to control the output voltage Vo. The output voltage Vo may be controlled by controlling the value of a target voltage VoX maintained in the second mode.

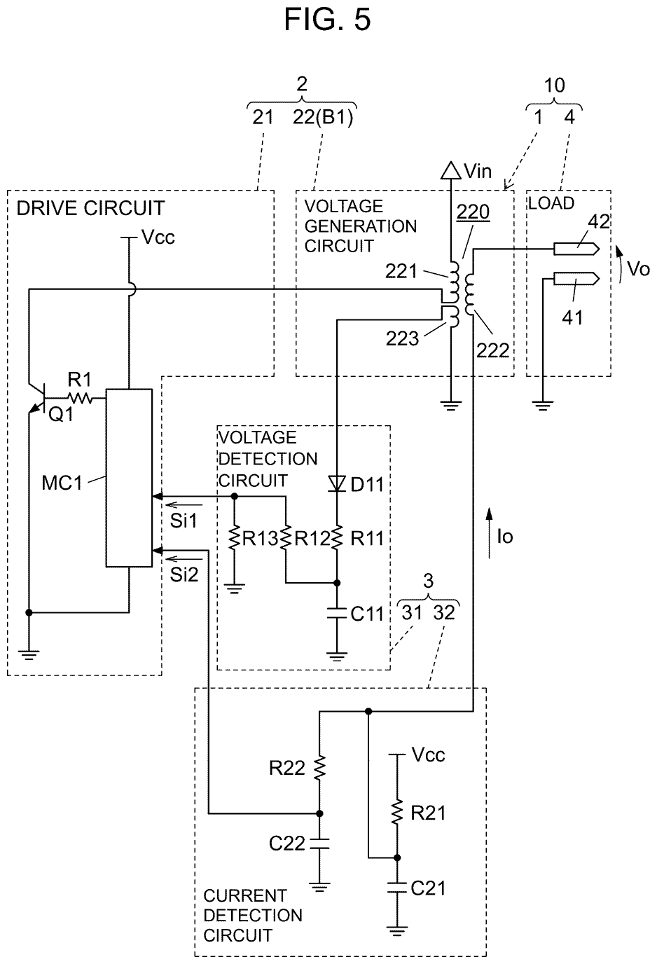

There is a correlation between the output voltage Vo of the voltage application circuit 2 (more specifically, a secondary voltage of an isolation transformer 220 in FIG. 5) and the input voltage Vin of the voltage application circuit 2 (more specifically, the primary voltage of the isolation transformer 220). Thus, the voltage detection circuit 31 may indirectly detect the output voltage Vo from the input voltage Vin. Similarly, there is a correlation between the output current Io of the voltage application circuit 2 (more specifically, the secondary current of the isolation transformer 220) and the input current of the voltage application circuit 2 (more specifically, the primary current of the isolation transformer 220). Thus, the current detection circuit 32 may indirectly detect the output current lo from the input current.

### (2.2) Circuit Configuration

Next, a specific circuit configuration of the voltage application device 1 will be described with reference to FIG. 5, which will be described. FIG. 5 is a circuit diagram schematically showing an example of a circuit configuration of the electrostatic atomizing apparatus 10. In FIG. 5, illustration of the power supply unit 6 is omitted.

As described above, the voltage application circuit 2 includes the drive circuit 21 and the voltage generation circuit 22. In the example of FIG. 5, the voltage application circuit 2 is an insulated DC/DC converter and includes a booster circuit B1. The booster circuit B1 boosts the input voltage Vin, which is a DC voltage, (for example, 13.8 V) from the power supply unit 6 and outputs the boosted voltage as the output voltage Vo. Here, the voltage generation circuit 22 functions as the booster circuit B1. The output voltage Vo is applied to the load 4 (more specifically, the discharge electrode 41 and the counter electrode 42). That is, voltage application circuit 2 applies periodically varying output voltage Vo to the load 4 to periodically allow the discharge electrode 41 to cause the electric discharge.

The voltage generation circuit 22 (for example, the booster circuit B1) includes the isolation transformer 220. The isolation transformer 220 includes a primary winding 221, a secondary winding 222, and an auxiliary winding 223. The primary winding 221 and the auxiliary winding 223 are electrically isolated from and magnetically coupled to the secondary winding 222. The counter electrode 42 is electrically connected to a first end of the secondary winding 222. That is, the booster circuit B1 includes the isolation transformer 220 that boosts the input voltage Vin input to the primary side (that is, to the primary winding 221) and outputs the output voltage Vo from the secondary side (that is, the secondary winding 222) electrically connected to the load 4.

The drive circuit 21 includes a transistor Q1, and is configured to supply power to the primary winding 221 of the isolation transformer 220 on the basis of a switching operation of the transistor Q1. In addition to the transistor Q1, the drive circuit 21 includes a microcontroller MC1 that drives the transistor Q1. The transistor Q1 is, for example, an npn bipolar transistor.

The collector of the transistor Q1 is connected to the primary winding 221, and the emitter of the transistor Q1 is connected to the ground. The input voltage Vin is applied from the power supply unit 6 to a series circuit of the primary winding 221 and the transistor Q1. The base of the transistor Q1 is connected to the output port of the microcontroller MC1 via a resistor R1.

The drive circuit 21 is connected to a control power supply. The control power supply generates a control voltage Vcc (for example, 5 V) and applies the control voltage Vcc to the microcontroller MC1.

In the above configuration, the voltage application circuit 2 constitutes a separately excited converter. That is, the transistor Q1 is repeatedly turned on and off by the microcontroller MC1, and a pulsed voltage is generated in the primary winding 221. As a result, a high voltage is induced in the secondary winding 222 of the isolation transformer 220. The high voltage induced in the secondary winding 222 is applied to the load 4. Through these operations, the voltage application circuit 2 generates the output voltage Vo by boosting the input voltage Vin, and applies the output voltage Vo to the load 4.

The detection circuit 3 includes the voltage detection circuit 31 and the current detection circuit 32, both of which are shown in FIG. 5.

The voltage detection circuit 31 includes a diode D11, resistors R11 to R13, and a capacitor C11. The anode of the diode D11 is connected to the first end of the auxiliary winding 223. The second end of the auxiliary winding 223 is connected to the ground. The cathode of the diode D11 is connected to the first end of the capacitor C11 via the resistor R11. The second end of the capacitor C11 is connected to the ground. Further, the first end of the capacitor C11 is connected to an input port of the microcontroller MC1 via the resistor R12, and is connected to the ground via a series circuit of resistors R12 and R13.

In the above configuration, the voltage detection circuit 31 indirectly monitors the output voltage Vo of the voltage application circuit 2 to be monitored (that is, the induced voltage of the secondary winding 222) by monitoring the induced voltage of the auxiliary winding 223. Specifically, the capacitor C11 is charged by the induced voltage of the auxiliary winding 223 via the diode D11 and the resistor R11. The voltage of the capacitor C11 divided by the resistors R12 and R13 is input to the input port of the microcontroller MC1 as the voltage detection signal Si1. When the output voltage Vo increases, the voltage detection signal Si1 (for example, voltage) increases. When the output voltage Vo decreases, the voltage detection signal Si1 decreases.

The current detection circuit 32 includes resistors R21 and R22 and capacitors C21 and C22. The control voltage Vcc is applied to a first end of the resistor R21, and a first end of the capacitor C21 is connected to a second end of the resistor R21. The second terminal of the capacitor C21 is connected to the ground. A connection point between the resistor R21 and the capacitor C21 is connected to the second end of the secondary winding 222 of the isolation transformer 220. The second end of the secondary winding 222 is an end opposite to the first end of the secondary winding 222. The counter electrode 42 is connected to a first end of the secondary winding 222. That is, the control voltage Vcc is applied to the counter electrode 42 via the resistor R21 and the secondary winding 222. The second end of the secondary winding 222 is connected to the ground via a series circuit of the resistor R22 and the capacitor C22. The voltage of the capacitor C22 is input to the input port of the microcontroller MC1 as the current detection signal Si2. When the output current Io increases, the current detection signal Si2 increases. When the output current Io decreases, the current detection signal Si2 decreases.

The microcontroller MC1 monitors the output voltage Vo based on the voltage detection signal Si1, and monitors the output current lo based on the current detection signal Si2. The microcontroller MC1 turns on and off the transistor Q1 based on the output voltage Vo and the output current lo.

(2.3) Electric discharge Control

FIG. 6 shows the control of the output voltage Vo by the voltage application circuit 2 of the present embodiment and the extension and contraction of the liquid 50 (for example, water) associated therewith. In FIG. 6, the horizontal axis represents time, the vertical axis represents voltage for the output voltage Vo, and the vertical axis represents the length of the liquid 50 (that is, the length in the direction in which the discharge electrode 41 and the counter electrode 42 face each other) for the extension and contraction of the liquid 50. FIG. 6 also shows a schematic diagram of the extension and contraction of the liquid 50.

When the voltage application circuit 2 periodically varies the output voltage Vo, the electric discharge is periodically generated between the discharge electrode 41 and the counter electrode 42. In the load 4, a potential difference between the discharge electrode 41 and the counter electrode 42 causes the electric discharge between the discharge electrode 41 and the counter electrode 42. The electric discharge generated between the discharge electrode 41 and the counter electrode 42 of the load 4 generates the radicals and electrostatically atomizes the liquid 50 held by the discharge electrode 41. Thus, the electrostatic atomizing apparatus 10 generates a charged fine particle liquid of nanometer size, the charged fine particle liquid containing the radicals in the fine droplets of the liquid 50 which has been electrostatically atomized. The generated charged fine particle liquid is released to the surroundings of the electrostatic atomizing apparatus 10 through the opening 4232 of the counter electrode 42, for example.

Assuming that a cycle in which the voltage application circuit 2 changes the output voltage Vo is an electric discharge cycle, in each electric discharge cycle, the voltage application circuit 2 first operates in the first mode to increase the output voltage Vo from a minimum value Vo1 to the predetermined magnitude Vo2. When the output voltage Vo reaches the predetermined magnitude Vo2, the voltage application circuit 2 shifts to the second mode. The second mode is a mode in which the output voltage Vo is maintained at the target voltage VoX that is greater than or equal to the predetermined magnitude Vo2. More specifically, in the second mode, the voltage application circuit 2 maintains the output voltage Vo at a voltage in a range, the range being not higher than an upper limit voltage Vo3 which is higher than target voltage VoX and the range being not lower than the predetermined magnitude Vo2. The upper limit voltage is a predetermined multiple (for example, 1.2 times) of the target voltage VoX. The predetermined magnitude Vo2 is a predetermined multiple (for example, 0.8 times) of the target voltage VoX. In other words, the upper limit voltage Vo3 is, for example, 1.5 times the predetermined magnitude Vo2.

The difference between the target voltage VoX and the predetermined magnitude Vo2 is smaller than the difference between the predetermined magnitude Vo2 and the minimum value Vo1. The difference between the predetermined magnitude Vo2 and the upper limit voltage Vo3 is smaller than the difference between the predetermined magnitude Vo2 and the minimum value Vo1.

In order to generate the electric discharge, the predetermined magnitude Vo2 is 3 kV or more. The predetermined magnitude Vo2 is preferably 3 kV, for example. That is, the second mode is preferably a mode in which the output voltage Vo is maintained at a voltage of 3 kV or more. The predetermined magnitude Vo2 is more preferably 3.5 kV. The predetermined magnitude Vo2 is more preferably 4 kV.

The voltage application circuit 2 increases the output voltage Vo in the first mode and maintains the output voltage Vo in the second mode by controlling the ON/OFF ratio (i.e., duty) of the transistor Q1.

In the second mode, as shown in the schematic view of FIG. 6, the liquid 50 is maintained in the extended state. In at least a part of the time from the start to the end of the second mode (that is, period T2), the electric discharge occurs between the discharge electrode 41 and the counter electrode 42, and the liquid 50 is electrostatically atomized.

The voltage application circuit 2 continues the second mode for a certain period of time. For this purpose, the microcontroller MC1 of the voltage application circuit 2 includes a timer and measures time with the timer. Instead of the timer, a feedback circuit may be provided to measure the time based on a feedback cycle.

At the end time of the second mode, the voltage application circuit 2 starts the third mode. The third mode is a mode in which the output voltage Vo is decreased with time. In the third mode, the voltage application circuit 2 keeps the transistor Q1 off, thereby decreasing the output voltage Vo with time. Thus, in the third mode, the output voltage Vo decreases to a voltage at which no electric discharge occurs.

The voltage application circuit 2 executes the fourth mode subsequently to the third mode. The period T4 in FIG. 6 is a time from the start to the end of the fourth mode. The fourth mode is a mode in which the output voltage Vo is maintained at a predetermined lower limit voltage or less. For example, as shown in FIG. 6, the voltage application circuit 2 maintains the output voltage Vo at the minimum value Vo1 in the fourth mode. In the present embodiment, the minimum value Vo1 is 0 V. That is, in the present embodiment, the fourth mode is a mode in which the output voltage Vo is maintained at 0 V. In other words, in the fourth mode, the voltage application circuit 2 does not apply the output voltage Vo to the load 4. The voltage application circuit 2 maintains the output voltage Vo at 0 V by maintaining the transistor Q1 off.

The minimum value Vo1 may be larger than 0 V. The voltage application circuit 2 may maintain the output voltage Vo at or below the lower limit voltage greater than 0 V in the fourth mode by controlling the ON/OFF ratio (i.e., duty) of the transistor Q1.

In the fourth mode, as shown in the schematic view of FIG. 6, the liquid 50 is contracted.

The voltage application circuit 2 continues the fourth mode for a certain period of time. For this purpose, the microcontroller MC1 of the voltage application circuit 2 includes a timer and measures time with the timer. Instead of the timer, a feedback circuit may be provided to measure the time based on a feedback cycle.

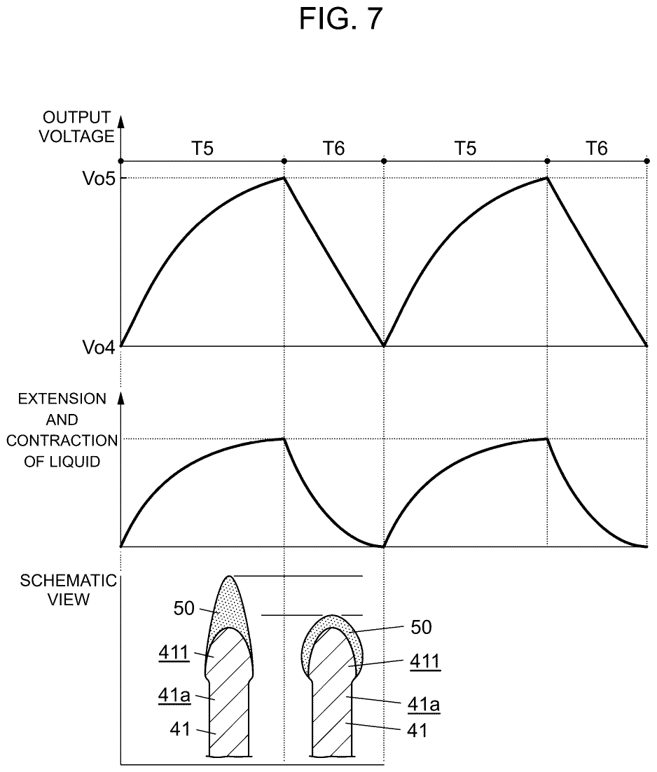

As a comparative example with respect to the present embodiment, FIG. 7 shows control of the output voltage Vo, the extension and contraction of the liquid 50 (for example, water) associated therewith, and schematic diagrams thereof, when the voltage application circuit 2 does not execute the second mode and the fourth mode. FIG. 7 is a graph and a schematic diagram schematically showing a change in the output voltage Vo and the extension and contraction of the liquid 50 of the electrostatic atomizing apparatus according to the comparative example. In FIG. 7, the control of increasing the output voltage Vo from a minimum value Vo4 to a maximum value Vo5 in a period T5 and the control of decreasing the output voltage Vo from the maximum value Vo5 to the minimum value Vo4 in a period T6 are alternately repeated. That is, in FIG. 7, the first mode and the third mode are alternately repeated.

On the other hand, the voltage application circuit 2 of the present embodiment executes first to fourth modes. Since the voltage application circuit 2 executes the second mode, a time during which the output voltage Vo equal to or greater than the predetermined magnitude Vo2 is applied to the load 4 is longer than a time in a case where the mode is shifted to the third mode immediately after the first mode. Thus, as compared with the case where the first mode and the third mode are alternately repeated as in the comparative example, the electric discharge can be performed in a state where the liquid 50 is uniformly extended every time, and thus the generation efficiency of the functional substance is improved.

The generation efficiency of the functional substance is evaluated on the basis of, for example, a generation amount of the functional substance generated with respect to a generation amount of ozone. It can be said that the larger the generation amount of the functional substance with respect to the generation amount of ozone, the higher the generation efficiency of the functional substance. By performing the electric discharge in a state where the liquid 50 is uniformly extended every time, it is possible to generate the functional substance and to suppress the generation amount of ozone. In addition, since it is possible to reduce an electric discharge energy between the discharge electrode 41 and the counter electrode 42, it is possible to suppress generation amounts of not only ozone but also NOₓ (for example, NO₂, which is a target substance of the environmental quality standards in the Basic Environment Act in Japan).

In addition, in the present embodiment, since the generation efficiency of the functional substance is improved as compared with the comparative example, the electric discharge current (that is, the output current lo) can be suppressed.

In addition, the time from the start to the end of the second mode can be sufficiently secured as the time for the extension of the liquid 50. That is, the liquid 50 is sufficiently extended. Therefore, the electric discharge can be generated at the output voltage Vo, which is relatively low.

Further, as described above, since the magnitude of the output voltage Vo periodically varies, the mechanical vibration occurs in the liquid 50. In the voltage application circuit 2 of the present embodiment, the vibration (for example, the extension and contraction) of the liquid 50 is suppressed by interposing the second mode between the first mode and the third mode, and thus sound (for example, electric discharge sound) generated by the vibration is suppressed. Specifically, as shown in FIG. 6, the extension and contraction of the liquid 50 is suppressed in the present embodiment as compared with the comparative example (see FIG. 7).

The third mode is a mode for interrupting the electric discharge of the load 4. However, the period T3 of the third mode alone may be insufficient to reach a sufficient period for interrupting the electric discharge. Therefore, the voltage application circuit 2 executes the fourth mode, thereby more reliably interrupting the electric discharge of the load 4. If the electric discharge continues for a long time without the interruption, the tip shape of the liquid 50 may be rounded. That is, if the electric discharge continues for a long time, there is a possibility that the Taylor cone shape of the liquid 50 is not maintained. As a result, the functional substance is less likely to be generated even when the second mode is continued. In contrast, by interrupting the electric discharge in the fourth mode, the tip shape of the liquid 50 is reset (that is, the liquid 50 is contracted). Accordingly, the Taylor cone is newly formed in the second mode of the next electric discharge cycle, and the functional substance is easily generated. That is, the generation efficiency of the functional substance is improved.

The voltage application circuit 2 performs the same control for each cycle (i.e., for each electric discharge cycle). That is, the voltage application circuit 2 sequentially executes the first mode, the second mode, the third mode, and the fourth mode during one cycle. The length of the one cycle is the sum of the lengths of the first mode, the second mode, the third mode, and the fourth mode (that is, the sum of the lengths of the periods T1, T2, T3, and T4).

The time from the start to the end of the second mode (that is, the length of the period T2) is 40% or more of the length of the one cycle. More specifically, the time from the start to the end of the second mode is preferably 40% or more and 60% or less of the length of the one cycle.

The time from the start to the end of the fourth mode (that is, the length of the period T4) is preferably 5% or more and 40% or less of the length of the one cycle. More specifically, the time from the start to the end of the fourth mode is more preferably 20% or more and 40% or less of the length of the one cycle.

The time from the start to the end of the first mode (that is, the length of the period T1) is preferably 5% or more and 15% or less of the length of the one cycle.

The time from the start to the end of the third mode (that is, the length of the period T3) is preferably 5% or more and 15% or less of the length of the one cycle. The time from the start to the end of the third mode is more preferably 10% or less of the length of the one cycle.

The lengths of the periods T1 and T3 are determined depending on, for example, characteristics of the isolation transformer 220. The periods T2 and T4 end under the control of the microcontroller MC1.

The length of the one period is preferably included in a predetermined range including a resonance period of the liquid 50. That is, the length of the one period is preferably set to be close to the resonance period of the liquid 50.

The length of one cycle is also preferably 1/3,000 seconds or more and 1/100 seconds or less. That is, the reciprocal of the length of the one cycle is preferably 100 Hz or more and 3 kHz or less.

The resonance period of the liquid 50 is a period during which the amplitude of the vibration of the liquid 50 caused by the fluctuation of the output voltage Vo is maximized. The resonance period of the liquid 50 depends on the volume (i.e., amount) of the liquid 50 and is expressed by [1/a·V−0.5], where “V” is the volume of the liquid 50 held in the discharge electrode 41 and where “a” is a proportionality coefficient depending on the surface tension and viscosity of the liquid 50 held by the discharge electrode 41.

For example, when the volume of the Taylor cone is 0.0917 mm³ and the volume of the second portion 4112 of the distal end portion 411 is 0.0650mm³, the volume of the liquid 50 forming the Taylor cone is 0.076 μL, and the resonance period of the liquid 50 at this time is 0.33 msec. In the present embodiment, the volume of the liquid 50 forming the Taylor cone is 0.46 μL, and the resonance period of the liquid 50 is 2 ms.

Specifically, the length of the one period is preferably equal to or less than a first value that is a value obtained by adding a half value of the resonance period to the resonance period and equal to or more than a second value that is a value obtained by subtracting the half value from the resonance period. For example, when the resonance period is 2 msec, the half value of the resonance period is 1 msec. In this case, the first value is 3 msec (=2 msec+1 msec), and the second value is 1 msec (=2 msec−1 msec). That is, the length of the one cycle is selected from a range of 1 msec or more and 3 msec or less. As a result, the production efficiency of the functional substance can be further improved.

### (3) Modifications

Modifications of the embodiment will be listed below. The following modifications may be implemented in combination as appropriate.

The shape of the counter electrode 42 is not limited to the shape described in the above-described embodiment, and may have any shape as long as the electric discharge occurs between the counter electrode 42 and the discharge electrode 41. For example, the counter electrode 42 may include a needle-shaped protrusion, and may be configured to generate a dielectric breakdown region between the needle-shaped protrusion and the discharge electrode 41.

The configuration of the liquid supply unit 5 is not limited to the configuration in which the discharge electrode 41 is cooled to generate the dew condensation water on the discharge electrode 41 as in the above-described embodiment. The liquid supply unit 5 may be configured to supply the liquid 50 from a tank to the discharge electrode 41 using, for example, a capillary phenomenon or a supply mechanism such as a pump. Further, the liquid 50 is not limited to water (including the dew condensation water), and may be a liquid other than water.

The voltage application circuit 2 may be configured to apply the output voltage Vo between the discharge electrode 41 and the counter electrode 42 in such a manner that the discharge electrode 41 serves as the positive electrode (for example, plus) and the counter electrode 42 as serves the negative electrode (for example, ground). Furthermore, to generate the potential difference (for example, the voltage) between the discharge electrode 41 and the counter electrode 42, the voltage application circuit 2 may apply a negative voltage to the load 4 by setting the electrode having the high potential (for example, the positive electrode) so as to be connected to the ground and setting the electrode having the low potential (for example, the negative electrode) so as to have a negative potential. That is, in the voltage application circuit 2, the discharge electrode 41 is set so as to be connected to the ground and the counter electrode 42 is set so as to have a negative potential. Alternatively, the discharge electrode 41 is set so as to be connected to have a negative potential and the counter electrode 42 is set so as to be connected to the ground.

The specific circuit configuration of the voltage application device 1 can be changed as appropriate. For example, the voltage application circuit 2 is not limited to a separately-excited converter, and may be a self-excited converter. The voltage generation circuit 22 may be realized by a transformer having a piezoelectric element (for example, a piezoelectric transformer).

In the electrostatic atomizing apparatus 10, the counter electrode 42 may be omitted. In this case, the electric discharge occurs between the discharge electrode 41 and a member present around the discharge electrode 41. An example of such a member is a housing.

Functions similar to those of the voltage application device 1 described above may be implemented by a method for controlling the voltage application circuit 2, a computer program, or a recording medium having the computer program recorded thereon. That is, the function of voltage application circuit 2 may be implemented by a method for controlling the voltage application circuit 2, a computer program, or a recording medium having the computer program recorded thereon.

The electrostatic atomizing apparatus 10 may generate ions as the functional substance.

The “monitoring target” of the detection circuit 3 may be at least one of the output current lo or the output voltage Vo of the voltage application circuit 2.

The voltage application circuit 2 may execute at least the first, second, and third modes, and it is not essential to execute the fourth mode.

The microcontroller MC1 of the above-described embodiment is used as a switch control device that drives the transistor Q1 as a switch. The switch control device is not limited to the microcontroller MC1, and may be configured by a plurality of discrete components.

### (4) Summary

The following aspects are disclosed from the embodiments described above.

An electrostatic atomizing apparatus (10) according to a first aspect includes a voltage application circuit (2). The voltage application circuit (2) is configured to apply an output voltage (Vo) to a load (4) including a discharge electrode (41) for holding a liquid (50) to cause electric discharge in the liquid held by the discharge electrode (41). The voltage application circuit (2) is configured to perform operation of one cycle a plurality of times, the operation of one cycle including executing a plurality of modes in a predetermined order. The plurality of modes include a first mode, a second mode subsequent to the first mode, and a third mode subsequent to the second mode. The first mode is a mode in which the output voltage (Vo) is increased with time. The second mode is a mode in which the output voltage (Vo) is maintained at a voltage equal to or higher than a predetermined magnitude (Vo2). The third mode is a mode in which the output voltage (Vo) is decreased with time. The predetermined magnitude (Vo2) of the output voltage (Vo) is 3 kV or more. A time from start to end of the second mode is 40% or more of a length of the one cycle.

In the above configuration, since the voltage application circuit (2) performs the operation in the second mode, the time during which the output voltage (Vo) equal to or higher than the predetermined magnitude (Vo2) is applied to the load (4) is longer than that in the case where the mode is shifted to the third mode immediately after the first mode. As a result, since the liquid (50) is electrically discharged in a uniformly extended state every cycle, the generation efficiency of the functional substance is improved.

In an electrostatic atomizing apparatus (10) according to a second aspect, which may be implemented in conjunction with the first aspect, the plurality of modes further include a fourth mode subsequent to the third mode. The fourth mode is a mode in which the output voltage (Vo) is maintained at a predetermined lower limit voltage or less.

In the above configuration, since the voltage application circuit (2) performs the operation of the fourth mode, the electric discharge in the liquid (50) can be interrupted. If the electric discharge is not interrupted, the tip shape of the liquid (50) becomes round, and thus the functional substance is less likely to be generated, even if the second mode is continued. On the other hand, by interrupting the electric discharge, the tip shape of the liquid (50) is reset (that is, the liquid (50) is contracted), and the functional substance is easily generated in the second mode of the next cycle.

In an electrostatic atomizing apparatus (10) according to a third aspect, which may be implemented in conjunction with the second aspect, the fourth mode is a mode in which the output voltage (Vo) is maintained at 0 V.

In the above configuration, the electric discharge in the liquid (50) can be more reliably interrupted.

In an electrostatic atomizing apparatus (10) according to a fourth aspect, which may be implemented in conjunction with the second or third aspect, a time period from start to end of the fourth mode is 5% or more and 40% or less of a length of one cycle.

In the above configuration, since the fourth mode continues for a relatively long time, the electric discharge in the liquid (50) can be more reliably interrupted. In addition, as compared with the case where the time from the start to the end of the fourth mode exceeds 40% of the length of the one cycle, it is possible to reduce possibility that the liquid (50) is contracted too much and that the generation efficiency of the functional substance is decreased.

In an electrostatic atomizing apparatus (10) according to a fifth aspect, which may be implemented in conjunction with any one of the second to fourth aspects, a time period from a start to an end of the third mode is 10% or less of a length of one cycle.

In the above configuration, it is possible to adopt a configuration in which the time from the start to the end of the third mode is relatively short. For example, in the configuration of FIG. 5, the time is determined depending on the characteristics of the isolation transformer (220). Thus, when the configuration in which the time is relatively short can be adopted, flexibility in selecting the isolation transformer (220) is increased. Even if the time is relatively short, since the voltage application circuit (2) performs the operation of the fourth mode, the time during which the output voltage (Vo) is low is extended. Thus, the electric discharge in the liquid (50) can be interrupted.

In an electrostatic atomizing apparatus (10) according to a sixth aspect, which may be implemented in conjunction with any one of the first to fifth aspects, a length of one cycle is included in a predetermined range including a resonance cycle of the liquid (50).

In the above configuration, the generation efficiency of the functional substance is improved.

In an electrostatic atomizing apparatus (10) according to a seventh aspect, which may be implemented in conjunction with any one of the first to sixth aspects, the length of one cycle is not less than 1/3,000 seconds and not more than 1/100 seconds.

In the above configuration, the generation efficiency of the functional substance is improved.

Configurations other than those of the first aspect are not essential to the electrostatic atomizing apparatus (10) and may be omitted as appropriate.

### REFERENCE SIGNS LIST

1 voltage application device
2 voltage application circuit
21 drive circuit
22 voltage generation circuit
220 isolation transformer
221 primary winding
222 secondary winding
223 auxiliary winding
3 detection circuit
31 voltage detection circuit
32 current detection circuit
4 load
40 housing
41 discharge electrode
41a shaft
41b base end portion
411 distal end portion
4111 first portion
4112 second portion
42 counter electrode
421 first recess portion
4211 bottom wall
422 support portion
423 protruding base portion
4231 top wall
4232 opening
424 second recess portion
425 annular edge portion
5 liquid supply unit
50 liquid
51 cooling device
511 Peltier element
512 heat radiation plate
6 power supply unit
10 electrostatic atomizing apparatus
B1 booster circuit
C11 capacitor
C21 capacitor
C22 capacitor
D11 diode
Io output current
MC1 microcontroller
Q1 transistor
R1 resistor
R11 resistor
R12 resistor
R13 resistor
R21 resistor
R22 resistor
Si1 voltage detection signal
Si2 current detection signal
Vcc control voltage
Vin input voltage
Vo Output voltage
Vo1 minimum value
Vo2 predetermined magnitude
Vo3 upper limit voltage
Vo4 minimum value
Vo5 maximum value
VoX target voltage
W1 distance

1. An electrostatic atomizing apparatus, comprising:
a voltage application circuit configured to apply an output voltage to a load including a discharge electrode for holding a liquid to cause electric discharge in the liquid held by the discharge electrode,
wherein
the voltage application circuit is configured to perform operation of one cycle a plurality of times, the operation of one cycle including executing a plurality of modes in a predetermined order,
the plurality of modes include a first mode, a second mode subsequent to the first mode, and a third mode subsequent to the second mode,
the first mode is a mode in which the output voltage is increased with time,
the second mode is a mode in which the output voltage is maintained at a voltage equal to or higher than a predetermined magnitude,
the third mode is a mode in which the output voltage is decreased with time,
the predetermined magnitude of the output voltage is 3 kV or more, and
a time from start to end of the second mode is 40% or more of a length of the one cycle.

2. The electrostatic atomizing apparatus according to claim 1, wherein
the plurality of modes further include a fourth mode subsequent to the third mode, and
the fourth mode is a mode in which the output voltage is maintained at a predetermined lower limit voltage or less.

3. The electrostatic atomizing apparatus according to claim 2, wherein
the fourth mode is a mode in which the output voltage is maintained at 0 V.

4. The electrostatic atomizing apparatus according to claim 2, wherein
a time from a start to an end of the fourth mode is 5% or more and 40% or less of the length of the one cycle.

5. The electrostatic atomizing apparatus according to claim 2, wherein
a time from a start to an end of the third mode is equal to or less than 10% of the length of the one cycle.

6. The electrostatic atomizing apparatus according to claim 1, wherein
a length of the one cycle is included in a predetermined range including a resonance period of the liquid.

7. The electrostatic atomizing apparatus according to claim 1, wherein
a length of the one cycle is 1/3,000 seconds or more and 1/100 seconds or less.
